(19) United States
(12) Patent Application Publication
(10) Pub. No.: US 2017/0272867 A1
(43) Pub. Date: Sep. 21, 2017

(54) Hearing aid

(71) Applicant: Radhear Ltd., Tel Aviv (IL)

(72) Inventors: Zohar Zisapel, Tel Aviv (IL); Yehonatan Hertzberg, Shoham (IL); Eliyahu Padan, Ramat Hasharon (IL)

(21) Appl. No.: 15/470,930

(22) Filed: Mar. 28, 2017

Related U.S. Application Data
(63) Continuation of application No. PCT/IB2017/051466, filed on Mar. 14, 2017.
(60) Provisional application No. 62/308,933, filed on Mar. 16, 2016.
(60) Provisional application No. 62/344,526, filed on Jun. 2, 2016.

(51) Int. Cl. H04R 25/00

(52) U.S. Cl. CPC H04R 25/407; H04R 25/405; H04R 25/305; H04R 25/554; H04R 29/006

(57) ABSTRACT

Hearing aid apparatus includes a case, which is configured to be physically fixed to a mobile telephone. An array of microphones are spaced apart within the case and are configured to produce electrical signals in response to acoustical inputs to the microphones. An interface is fixed within the case. Processing circuitry is fixed within the case and is coupled to receive and process the electrical signals from the microphones so as to generate a combined signal for output via the interface.

### CROSS-REFERENCE TO RELATED APPLICATIONS

This application is a continuation of PCT Patent Application PCT/IB2017/051466, filed Mar. 14, 2017, which claims the benefit of U.S. Provisional Patent Application 62/308,933, filed Mar. 16, 2016, and of U.S. Provisional Patent Application 62/344,526, filed Jun. 2, 2016. All of these related applications are incorporated herein by reference.

### FIELD OF THE INVENTION

The present invention relates generally to hearing aids, and particularly to devices and methods for improving directional hearing.

### BACKGROUND

Speech understanding in noisy environments is a significant problem for the hearing-impaired. Hearing impairment is usually accompanied by a reduced time resolution of the sensorial system in addition to a gain loss. These characteristics further reduce the ability of the hearing-impaired to filter the target source from the background noise and particularly to understand speech in noisy environments.

Some newer hearing aids offer a directional hearing mode to improve speech intelligibility in noisy environments. This mode makes use of an array of microphones and applies beamforming technology to combine multiple microphone inputs into a single, directional output audio channel. The output channel has spatial characteristics that increase the contribution of acoustic waves arriving from the target direction relative to those of the acoustic waves from other directions. Widrow and Luo survey the theory and practice of directional hearing aids in “Microphone arrays for hearing aids: An overview,” Speech Communication 39 (2003), pages 139-146, which is incorporated herein by reference.

Some authors have proposed hearings aids based on microphone arrays that are integrated into spectacle frames. For example, U.S. Pat. No. 7,609,842 describes a hearing aid/spectacles combination that includes a spectacle frame and a first reproduction unit. The spectacle frame has a microphone array in a first spectacle arm. The microphone array is able to pick up a sound signal and is able to transmit a processed signal, produced on the basis of the sound signal, to the first reproduction unit. The hearing aid/spectacles combination includes a sound registration module that includes the microphone array; a beam forming module for forming a direction-dependent processed signal; a reproduction adaptation module for controlling a reproduction characteristic of the processed sound signal produced by the first reproduction unit; a reproduction module that comprises the first reproduction unit; and a reproduction control module for controlling a reproduction characteristic of the processed sound signal produced by the first reproduction unit.

### SUMMARY

Embodiments of the present invention that are described hereinbelow provide improved hearing aids, as well as methods for optimizing hearing aid performance.

There is therefore provided, in accordance with an embodiment of the invention, hearing aid apparatus, including a case, which is configured to be physically fixed to a mobile telephone, and an array of microphones, which are spaced apart within the case and are configured to produce electrical signals in response to acoustical inputs to the microphones. An interface is fixed within the case, along with processing circuitry, which is coupled to receive and process the electrical signals from the microphones so as to generate a combined signal for output via the interface.

In some embodiments, the case has four sides and a rear face, to which the four sides are connected, which are shaped and sized so that the case fits over the mobile telephone, while the microphones are fixed within at least two of the sides of the case. Typically, the case has a rounded rectangular form. In a disclosed embodiment, the microphones are spaced apart within at least three of the sides of the case. Additionally or alternatively, the microphones are embedded in the sides of the case, and the sides contain audio ports extending outward from the microphones in a direction away from the rear face.

In a disclosed embodiment, the array of microphones includes at least eight microphones.

In some embodiments, the combined signal includes an audio output, and the processing circuitry is configured to generate the audio output by mixing the electrical signals in accordance with a directional response that is dependent on an angular orientation of the case. Typically, the directional response defines a beam direction and an angular aperture around the beam direction, such that the acoustical inputs within the angular aperture are emphasized in the audio output by the processing circuitry, while suppressing the acoustical inputs outside the angular aperture. In one embodiment, the processing circuitry is configured to receive from the mobile telephone, via the interface, an instruction indicating at least one of the beam direction, relative to the angular orientation of the case, and the angular aperture. The instruction can be generated, for example, in response to an input received from a user by an application running on the mobile telephone.

Additionally or alternatively, the interface includes an audio interface, which is configured to convey the audio output to an earphone. In one embodiment, the earphone includes an inertial sensor, which is configured to generate an indication of a rotational angle of a head of a person wearing the earphone, and the processor is configured to adjust the directional response in accordance with the indication of the rotational angle.

Further additionally or alternatively, the interface includes a device interface, which communicates with the mobile telephone. In some embodiments, the combined signal is processed by an application running on the mobile telephone so as to generate an audio output in accordance with a directional response that defines a beam direction and an angular aperture around the beam direction, such that the acoustical inputs within the angular aperture are emphasized by the application, while suppressing the acoustical inputs outside the angular aperture.

There is also provided, in accordance with an embodiment of the invention, hearing aid apparatus, including a spectacle frame and an array of microphones, which are fixed within the spectacle frame and are configured to produce electrical signals in response to acoustical inputs to the microphones. Processing circuitry, which is fixed within the spectacle frame, is coupled to receive and mix the electrical signals from the microphones so as to generate an audio output with a directional response that is dependent on an angular orientation of the frame. An inductive coil connected to the spectacle frame is coupled to be driven by the processing circuitry to convey the audio output as a magnetic signal to a telecoil in a hearing aid of a user who is wearing the spectacle frame.

In a disclosed embodiment, the inductive coil is rotatable relative to the spectacle frame so as to optimize a mutual inductance between the inductive coil and the telecoil.

There is additionally provided, in accordance with an embodiment of the invention, a method for hearing aid calibration, which includes providing a hearing aid including an array of microphones that are configured to be disposed at different, respective locations around a part of a body of a human subject who is wearing the hearing aid, and processing circuitry coupled to receive and mix electrical signals from the microphones so as to generate an audio output to the subject with a specified directional response. Respective acoustic transfer functions of a plurality of test subjects are recorded, and respective optimal beamforming coefficients are defined, to be applied by the processing circuitry of the hearing aid in generating the audio output for each of the acoustic transfer functions. For a new subject who is a candidate to use the hearing aid, a nearest match is found among the recorded acoustic transfer functions. The hearing aid for the new subject is set to apply the respective optimal beamforming coefficients that were defined for the nearest match among the recorded acoustic transfer functions.

In one embodiment, the hearing aid includes a spectacle frame in which the array of microphones is fixed.

In a disclosed embodiment, defining the respective optimal beamforming coefficients includes positioning an audio source at each of a first set of locations within an angular aperture of the specified directional response, and actuating the audio source to generate sounds at a second set of frequencies at each of the locations. The beamforming coefficients are set so that the audio output reproduces the sounds with a maximal fidelity, while minimizing a contribution to the audio output of acoustic waves originating outside the angular aperture.

In some embodiments, finding the nearest match includes measuring an acoustic transfer function of the new subject, and matching the measured acoustic transfer function of the new subject to the recorded acoustic transfer functions. Additionally or alternatively, finding the nearest match includes matching physical characteristics of the new subject to the test subjects.

There is further provided, in accordance with an embodiment of the invention, a method for hearing assistance, which includes providing a case, containing an array of microphones spaced apart within the case, and configured to be physically fixed to a mobile telephone. Electrical signals from the microphones are mixed so as to generate a combined audio signal, which is output to an earphone.

There is moreover provided, in accordance with an embodiment of the invention, a method for audio processing, which includes providing a case, containing an array of microphones spaced apart within the case, and configured to be physically fixed to a mobile telephone. A video image is captured, using a camera in the mobile telephone, of an audio source. Electrical signals from the microphones are mixed in accordance with a directional response that is directed toward the audio source so as to generate a combined audio output signal.

In some embodiments, the method includes recording the video image together with the combined audio output signal. Additionally or alternatively, the method includes transmitting the video image together with the combined audio output signal over a communication network.

The present invention will be more fully understood from the following detailed description of the embodiments thereof, taken together with the drawings in which:

### BRIEF DESCRIPTION OF THE DRAWINGS

FIG. 1 is a schematic pictorial illustration showing the use of a hearing aid that is integrated into a case of a mobile telephone, in accordance with an embodiment of the invention;

FIG. 2 is a schematic pictorial illustration showing details of a user interface of the hearing aid of FIG. 1, in accordance with an embodiment of the invention;

FIG. 3 is a schematic pictorial illustration of a directional microphone assembly, in accordance with an embodiment of the invention;

FIG. 4 is a schematic pictorial illustration of a hearing aid that is integrated into a case of a mobile telephone, in accordance with an embodiment of the invention;

FIG. 5 is a schematic pictorial illustration and block diagram of a wireless earphone for use with a hearing aid, in accordance with an embodiment of the invention;

FIG. 6 is a schematic pictorial illustration of a hearing aid that is integrated into a spectacle frame, in accordance with an embodiment of the invention; and

FIG. 7 is a flow chart that schematically illustrates a method for calibrating a directional hearing mode of a hearing aid, in accordance with an embodiment of the invention.

### DETAILED DESCRIPTION OF EMBODIMENTS

### Overview

Despite the need for directional hearing assistance and the theoretical benefits of microphone arrays in this regard, in practice the directional performance of hearing aids falls far short of that achieved by natural hearing. Part of the problem is that each person's body has a different acoustic transfer function, which modifies the acoustic inputs that are received by an array of microphones on the body (for example, microphones mounted across a spectacle frame or necklace). Therefore, the set of beamforming coefficients that are applied in mixing the electrical signals from the microphones must generally be adjusted individually for each user to give the desired directional response. The required adjustments are complex and difficult to implement in a simple clinical or commercial setting. Furthermore, many people are put off by the aesthetic appearance of the personal accessories, such as spectacle frames and necklaces, that contain hearing-aid microphone arrays.

Embodiments of the present invention that are described herein provide solutions that make directional hearing capability in a hearing aid practical and user-friendly. In some of these embodiments, the microphone array is embedded in a case that is physically fixed to a mobile telephone. The microphones are spaced apart within the case, thus providing a wide baseline for the array (on the order of 10 cm). Processing circuitry, which is also fixed within the case, receives and processes the electrical signals from the microphones so as to generate a combined signal for output via an interface.

In some embodiments, the processing circuitry itself mixes the electrical signals in accordance with a directional response that is dependent on the angular orientation of the case, and thus generates audio output to an earphone (or pair of earphones) worn by the user. In other embodiments, the processing circuitry simply digitizes and multiplexes the signals for output to the mobile telephone over which the case is fitted, and an application running on the mobile telephone generates the combined, directional audio output. In either case, to operate the hearing aid, the user simply places the mobile telephone in a convenient location, such as on a tabletop, and aims it in the direction of the audio source (such as a conversation partner) that the user wishes to hear. The hearing aid will amplify the sounds coming from a certain angular aperture around the desired direction, while suppressing acoustical inputs outside the angular aperture. The use of the hearing aid in this manner is unobtrusive, and the effect of the acoustic transfer function of the user's body is negligible.

Optionally, the beam direction, relative to the case containing the microphone array, and/or the angular aperture applied in generating the audio output can be set by an application running on the mobile telephone. This option can be implemented whether the actual processing is carried out by the application itself or by the processing circuitry in the case, which receives the beamforming instructions from the application via an interface between the case and the mobile telephone. In some embodiments, the application provides a user interface that enables the user to set the beam direction and/or aperture, for example via the touch screen of the mobile telephone.

Other embodiments of the present invention provide methods for hearing aid calibration, which enable easier and more reliable selection of the beamforming coefficients that are to be applied in mixing the signals from an array of microphones on a part of the user's body (such as the head or chest) to give a desired directional response. For this purpose, a database of hearing aid parameters is created by recording the acoustic transfer functions of a group of test subjects, and then defining optimal beamforming coefficients to be applied by the hearing aid for each of the acoustic transfer functions. Thereafter, when a new subject is a candidate to use the hearing aid, the optimal beamforming coefficients are chosen from the database by finding the nearest match to the new subject among the recorded acoustic transfer functions. The nearest match may be found, for example, by matching physical characteristics of the new subject to the test subjects or, alternatively or additionally, by measuring the acoustic transfer function of the new subject. In the latter case, a less thorough measurement of the acoustic transfer function (relative to the measurements made in the stage of creating the database) may be sufficient.

### Microphone Array in Mobile Phone Case

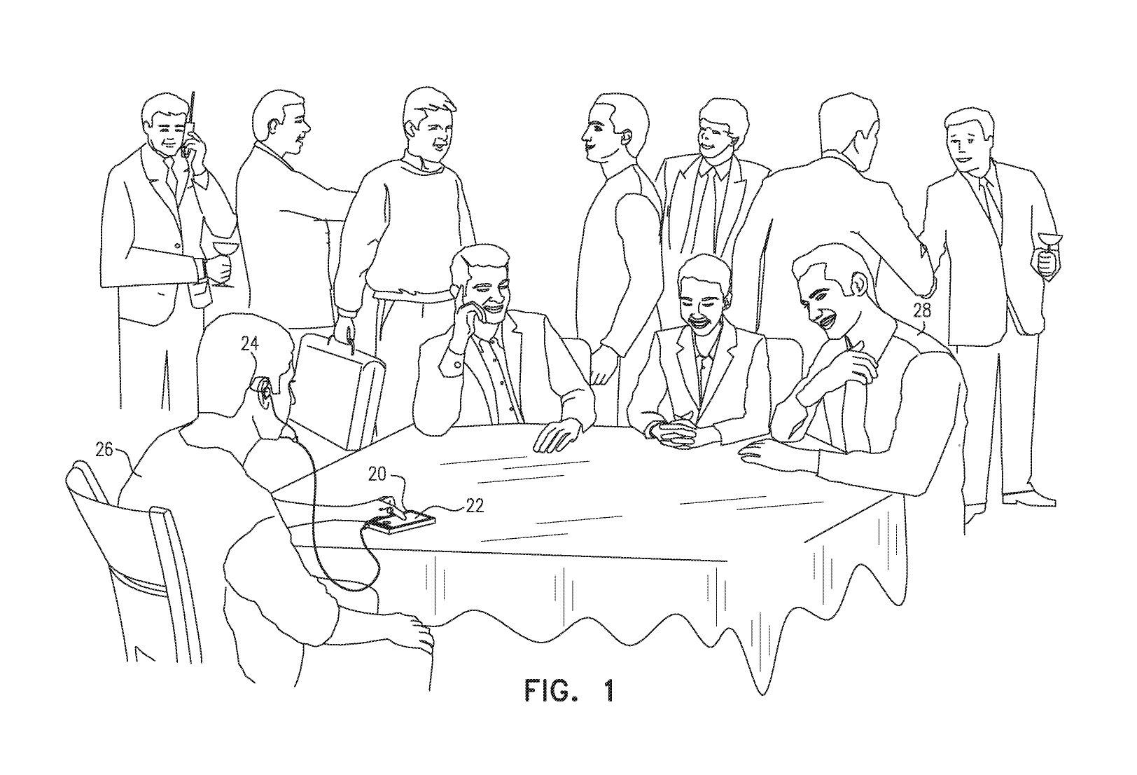

FIG. 1 is a schematic pictorial illustration showing the use of a hearing aid 20 that is integrated into a case of a mobile telephone 22, in accordance with an embodiment of the invention. Hearing aid 20 (possibly with the assistance of an application running on telephone 22) generates an audio output to earphones 24 worn by a user 26 by mixing the electrical signals output by an array of microphones that are fixed within at least two of the sides of the case, as shown in the figures that follow. (Alternatively, a single earphone may be sufficient for some users.) The signals are mixed in accordance with a directional response that is dependent on the angular orientation of the case, and hence of telephone 22.

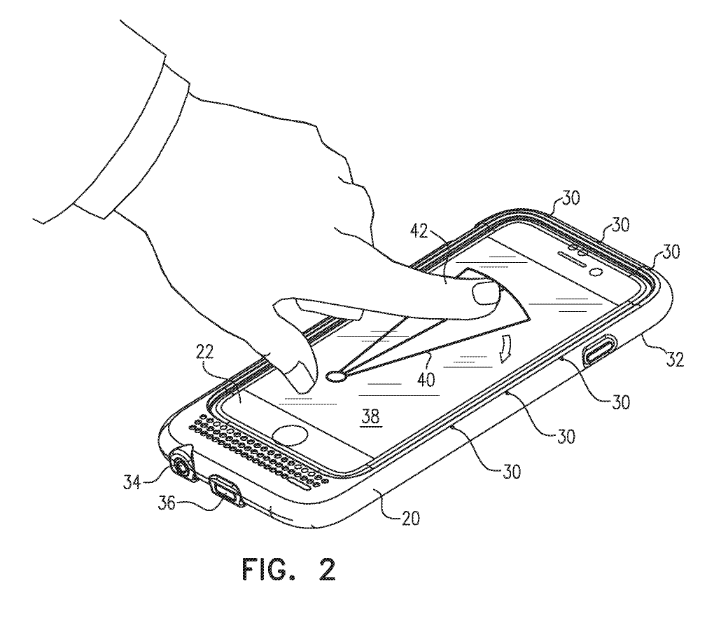

In the pictured example, user 26 turns telephone to point toward an audio source of interest, such as a person 28 with whom user 26 is speaking, and thus directs the beam of the microphone array in that direction. Alternatively or additionally, user 26 may input directional instructions to hearing aid 20 via the user interface of telephone 22, as illustrated in FIG. 2. Further alternatively or additionally, hearing aid 20 may automatically choose the beam direction based on the directions of sounds that it receives. In any case, in the audio output to earphones 24, hearing aid 20 emphasizes acoustical inputs originating within a certain angular aperture surrounding the beam direction, while suppressing the acoustical inputs outside the angular aperture. User 26 is thus able to hear person 28 clearly, with less interference by background noise from the environment.

Additionally or alternatively, the principles of hearing aid 20 may be applied for other purposes, not limited to assisting those with hearing loss, such as to enhance audio signals in conjunction with video transmission and/or recording. For example, in a video conferencing scenario, the user may hold telephone 22 upright, so that images of the participants are captured by the front and/or rear camera that is built into the telephone. The beam of the microphone array is directed, either automatically or under control of the user, toward whichever participant is speaking at any given moment. Thus, the remote participants will receive over a communication network, together with the video, a clearer speech signal, with reduced background noise. Similar principles may be applied to enhance audio reception in conjunction with video recording, so that the soundtrack of a movie recorded by telephone 22 contains the speech or other sounds of interest with reduced background interference.

FIG. 2 is a schematic pictorial illustration showing details of hearing aid 20, including the user interface provided by telephone 22, in accordance with an embodiment of the invention. Hearing aid 20 comprises a rectangular case 32, which fits over mobile telephone 22. In the pictured embodiment, case 32 has a rounded rectangular form (i.e., a rectangle with rounded corners), matching the form of popular smartphones that are known in the art. Hearing aid 20 comprises multiple microphones embedded in the sides of case 32 (as shown in the figures that follow), with audio ports 30 extending outward from the microphones in a direction away from the rear face of the case and opening through the front of the case. This orientation of ports makes it unlikely that acoustic access to the microphones will be blocked while hearing aid 20 is in use. The lengths of the ports are short, typically no more than a few millimeters, to avoid creating acoustic resonances.

Although the pictured embodiments show case 32 as being fixed to telephone 22 by actually fitting over the telephone shell, in other embodiments (not shown in the figures) the case of the hearing aid may physically fixed to the telephone by other means. For example, the hearing aid case may be glued onto the back of the telephone by a suitable adhesive, or possibly clipped over the telephone. In any case, the microphones are spaced apart within the case in order to provide a wide baseline for purposes of beamforming.

Hearing aid 20 typically has a number of interfaces: An audio interface 34 conveys the audio output from the hearing aid to earphones 24. Alternatively, the audio output may be conveyed in digital form over a suitable wireless link to the earphones, either from a wireless interface in case 32 or from a wireless interface in telephone 22, such as a Bluetooth™ interface. A power interface 36 in case 32 can be plugged into a charger, which provides electrical power to recharge batteries in hearing aid 20 and/or telephone 22.

In addition, hearing aid 20 comprises a telephone interface (shown in the figures that follow), which communicates with the processor in telephone 22 in accordance with the appropriate standard, over a wired or wireless link depending on the type of telephone. This link enables hearing aid 20 to receive instructions from a hearing aid application running on telephone 22 (or more precisely, running on the processor in the telephone), as well as to output digital audio signals to the telephone.

The hearing aid application enables user 26 to control the operation of hearing aid 20 via the user interface of telephone 22, for example by interacting with a touch screen 38. In the pictured embodiment, touch screen 38 displays an icon 40, which indicates the beam direction, relative to the current orientation of case 32 and telephone 22, and the angular aperture around the beam direction that are to be applied in mixing the electrical signals from the microphone array in the hearing aid. The user can contact touch screen 38 with his fingers 42 in order change the angular aperture and/or the beam direction of hearing aid 20. Alternatively or additionally, the user may set hearing aid 20 for omnidirectional operation, or may select automatic setting of the beamforming parameters. In this latter case, the application may set the parameters to give the best possible ratio between a speech signal received by the hearing aid and background sounds.

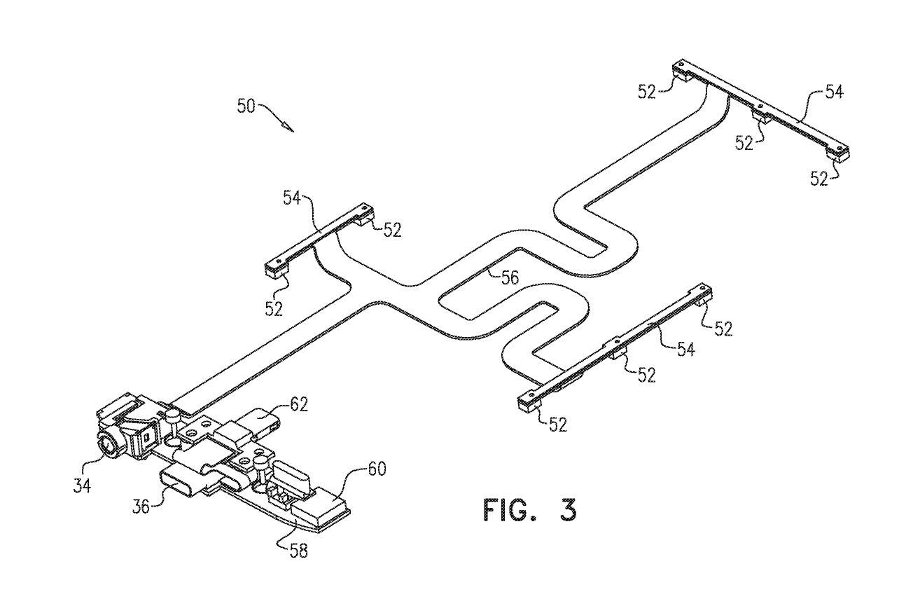

The instructions generated by the application (under user control or automatically) cause the beamforming coefficients that are applied in mixing the signals from the microphones in hearing aid 20 to be set and modified as needed in order to implement the specified directional response. Alternatively, the beamforming coefficients, or at least the beam direction coefficients, may be fixed, in which case user 26 sets the beam direction simply by turning telephone 22 in the desired direction. As noted earlier, the mixing of the microphone signals may be performed either by processing circuitry within case 32 (as shown in FIG. 3) or by the application running on telephone 22.

Additionally or alternatively, other functions and parameters of hearing aid 20 may be controlled via touch screen 38. For example, the hearing aid application may present controls that enable user 26 to set the audio volume and frequency equalization that is applied to each of earphones 24. The specific user interface features shown in FIG. 2 are presented only by way of illustration, and various other user interface designs and features may be implemented on telephone 22 and are considered to be within the scope of the present invention.

FIG. 3 is a schematic pictorial illustration of a directional microphone assembly 50 that is encapsulated in case 32 of hearing aid 20, in accordance with an embodiment of the invention. Microphones 52 are mounted on printed circuit boards 54, which are then embedded inside the sides of case 32. In the pictured embodiment, assembly 50 comprises eight microphones 52, which are spaced apart within three sides of case 32. The inventors have found that this arrangement facilitates precise control of the beam direction and aperture. Alternatively, smaller or larger numbers of microphones may be used, within two, three, or all four sides of case 32. Microphones 52 may conveniently comprise any suitable types of acoustic transducers that are known in the art, such as MEMS devices or miniature piezoelectric transducers, for example. (The term transducer is used broadly, in the context of the present description, to refer to any device that converts acoustic waves into an electrical signal, or vice versa.)

Printed circuit boards 54 are connected by conductors in a flexible printed circuit 56 to a main processing board 58, on which processing circuitry 60 is mounted. In the pictured embodiment, audio interface 34 and power interface 36 are also mounted on board 58, as is a telephone interface 62, which communicates with mobile telephone 22, and other components, such as a rechargeable battery and power circuits.

Processing circuitry 60 is shown in FIG. 3 as a single integrated circuit chip. Alternatively, the functions of the processing circuitry may be distributed among multiple chips, which may be located on board 58 or at other locations in assembly 50 (such as on printed circuit boards 54 or printed circuit 56). Typically, processing circuitry 60 comprises an analog/digital converter, which digitizes the analog electrical outputs of microphones 52, along with digital processing circuitry for mixing the digitized signals. In some embodiments, this mixing function is limited to multiplexing the digitized signals and conveying them over interface 62 to telephone 22, which applies the appropriate beamforming function and generates the audio output.

In other embodiments, processing circuitry 60 performs the beamforming functions of hearing aid 20. For this purpose, processing circuitry 60 comprises suitable programmable logic components, such as a digital signal processor or a gate array, which implement the necessary filtering and mixing functions in accordance with the appropriate beamforming coefficients. Alternatively or additionally, processing circuitry 60 may comprise a neural network, which is trained to determine and apply the beamforming coefficients. Further alternatively or additionally, processing circuitry 60 comprises a microprocessor, which is programmed in software or firmware to carry out at least some of the functions that are described herein.

Processing circuitry 60 and/or the processor in telephone 22 may apply any suitable beamforming algorithm that is known in the art in mixing the signals that are output by microphones 52, such as the algorithms described in the above-mentioned article by Widrow and Luo. The algorithm may be applied equivalently in either the time domain or the frequency domain. For example, a time delay algorithm may be used to combine the electrical signals with time shifts equal to the propagation times of the acoustic waves between the microphone locations with respect to the desired beam direction. Alternatively, a Minimum Variance Distortionless Response (MVDR) beam former algorithm may be applied in order to achieve better spatial resolution. Other applicable beamforming techniques are based on Linear Constraint Minimum Variance (LCMV) and General Sidelobe Canceller (GSC) algorithms.

The more advanced algorithms (such as MVDR, LCMV and GSC) require information about the noise in addition to the information about the target and the microphone array. The MVDR algorithm maximizes the signal-to-noise ratio (SNR) by minimizing the average energy (while keeping the target distortion small). The implementation of this algorithm can be performed in frequency space by calculating complex weights for each microphone at each frequency as expressed by the following formula:

$$w = \frac{{R}_{x}^{- 1} d ( θ , ω )}{{d}^{H} ( θ , ω ) {R}_{X}^{- 1} d ( θ , ω )}$$

Here Rₓ is the covariance matrix, and W is a vector of the complex weights of the desired frequency response d at angle θ and frequency ω. In order to apply the vector of frequency space weights, W, processing circuitry 60 computes and multiplies the short-time Fourier transform (SIFT) of the signal output by each microphone, sums all the resulting values, and applies an inverse Fourier transform to convert the result back to the time domain. Spectral leakage can be reduced by applying a window function, such as a Hamming window. An overlap-add (OLA) method can be applied to stitch the SIFT parts of the signal together into a smooth audio output stream.

In addition, in order to improve the quality of the audio output from hearing aid 20, processing circuitry 60 (or the processor in telephone 22) may perform one or more addition audio enhancement functions, such as:

i. Frequency band analysis;

ii. Feedback cancellation;

iii. Equalization;

iv. Noise reduction;

v. Automatic gain control;

vi. Frequency band synthesis; and

vii. Stereo output synthesis.

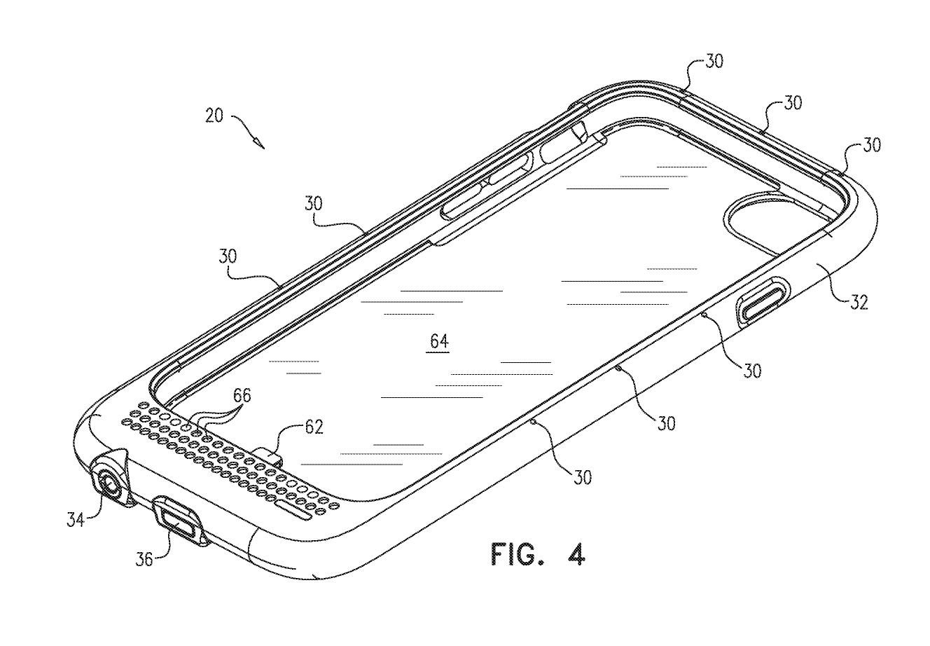

FIG. 4 is a schematic pictorial illustration showing how the components of hearing aid 20 are encapsulated within case 32, in accordance with an embodiment of the invention. The four sides and a rear face 64 of case 32 typically comprise a suitable flexible plastic, which is molded over microphone assembly 50. The case is thus suitable to fit over the body of telephone 22, with telephone interface 62 engaging the corresponding receptacle provided in the telephone body. Holes 66 are left in case 32 to enable use of the built-in microphone in telephone 22 for phone calls, along with other appropriate holes for the telephone camera and controls, as shown in FIG. 4.

Although the above figures show a particular design of case 32 and assembly 50 that the inventors have found to be advantageous, these elements of hearing aid 20 are shown solely by way of illustration. Other designs for directional hearing aids that are integrated within the case of a mobile telephone will be apparent to those skilled in the art after reading the present description and are considered to be within the scope of the present invention.

### Wireless Earphones for Use with a Directional Hearing Aid

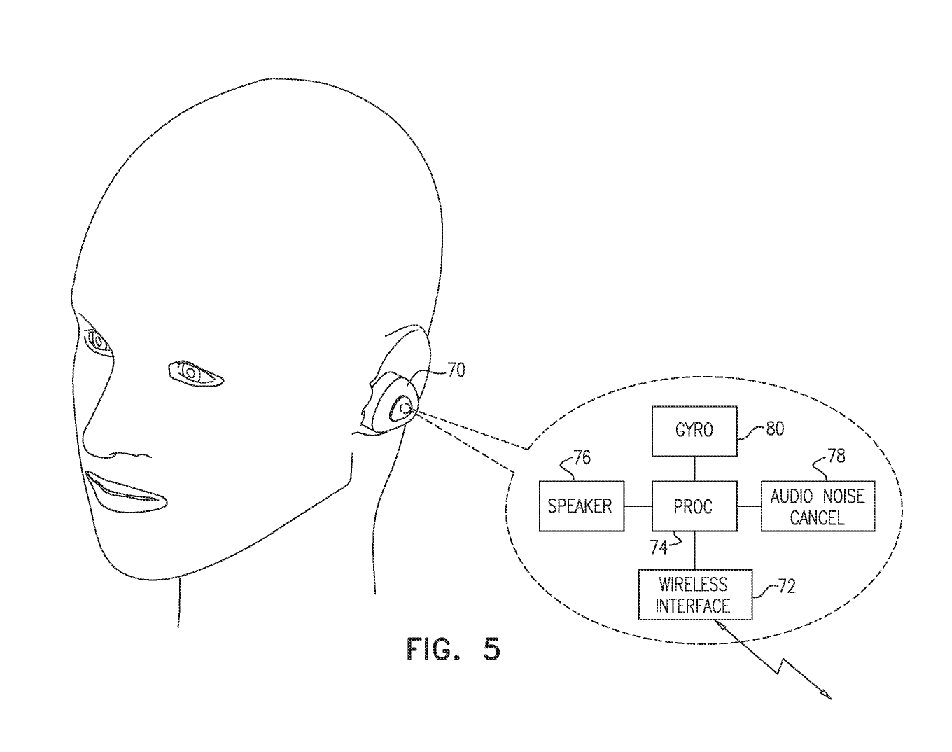

FIG. 5 is a schematic pictorial illustration and block diagram of a wireless earphone 70 for use with a hearing aid, in accordance with an embodiment of the invention. Earphone 70 may be used in conjunction with hearing aid 20, as described above, or in conjunction with other sorts of directional hearing aids that are known in the art.

Earphone 70 comprises a wireless interface 72, such as a Bluetooth interface, which receives digital audio signals over the air from hearing aid 20 (either via the built-in wireless interface of telephone 22 or via a dedicated wireless interface of the hearing aid). Alternatively, earphone 70 may receive input audio signals over a wire connecting to audio interface 34. A processor 74 converts the digital audio signals to an analog audio output, which drives a speaker 76. Typically, processor 74 comprises an integrated circuit chip, including suitable digital logic, digital and analog interfaces, amplifiers, and conversion circuits (digital-to-analog and analog-to-digital) for performing the functions described herein.

Optionally, earphone 70 includes an additional audio noise cancellation circuit 78, comprising one or more microphones, which generates a signal indicative of ambient noise in the vicinity of earphone 70. Processor 74 may subtract this noise signal from the audio signal received via interface 72 in order to cancel the noise out of the audio output played by speaker 76. This mode of operation is also known as active noise control.

In the pictured embodiment, earphone 70 also comprises an inertial sensor 80, commonly referred to as a “gyro” sensor, which provides an indication of movements of earphone 70 and thus of the user's head. Specifically, sensor 80 generates an indication of the rotational angle of the head of the person wearing the earphone, and processor 74 conveys this indication via wireless interface 72 to telephone 22 or to processing circuitry 60. The application running on telephone 22 or the processing circuitry can then adjust the directional response of hearing aid 20 in accordance with the rotational angle of the head. Thus, the hearing aid may be controlled automatically, for example, so that the beam direction is aligned with the user's gaze direction at any given time.

### Hearing Aid Embedded in a Spectacle Frame

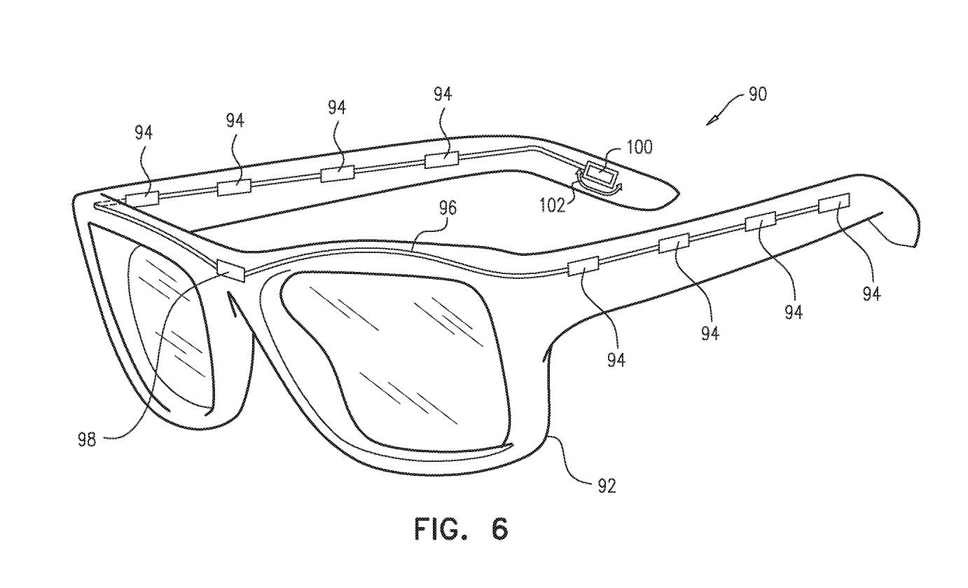

FIG. 6 is a schematic pictorial illustration of a hearing aid 90 that is integrated into a spectacle frame 92, in accordance with another embodiment of the invention. An array of microphones 94 are fixed within spectacle frame 92 and produce electrical signals in response to acoustical inputs to the microphones. Processing circuitry 98 is fixed within the spectacle frame and is coupled by electrical wiring 96, such as traces on a flexible printed circuit, to receive the electrical signals from microphones 94. Processing circuitry 98 mixes the signals from the microphones so as to generate an audio output with a directional response that is aligned with the angular orientation of frame 92. Microphones 94 and circuitry 98 are similar in structure and operation to the corresponding components of hearing aid 20, with the exception of the features of hearing aid 20 that are specifically associated with mobile telephone 22.

Processing circuitry 98 may convey the directional audio output to the user's ear via any suitable sort of interface and speaker. In the pictured embodiment, however, processing circuitry 98 drives an inductive coil 100 to convey the audio output as a magnetic signal to a telecoil in a hearing aid (not shown) of a user who is wearing the spectacle frame. Coil 100 is connected to spectacle frame 92 (and may be contained within the frame). This sort of interface is advantageous in making use of telecoils that are already installed in many hearing aids for the purpose of receiving audio input from a telephone handset. The user can wear spectacle frame 92 when enhanced directional hearing is desired and rely on the hearing aid alone otherwise.

To enhance the magnetic coupling between inductive coil 100 and the telecoil in the user's hearing aid, coil 100 is rotatable relative to spectacle frame 92, as indicated by a curved arrow 102 in FIG. 6. This feature is useful in particular because telecoils in different sorts of hearing aids may be oriented at different angles. For example, coil 100 may be mounted on a suitable thumbwheel. The user can then rotate coil 100 to an angle that maximizes the mutual inductance between the coil 100 and the telecoil in the hearing aid, thereby optimizing the quality of the audio that is received and output by the hearing aid.

### Calibration of Directional Response

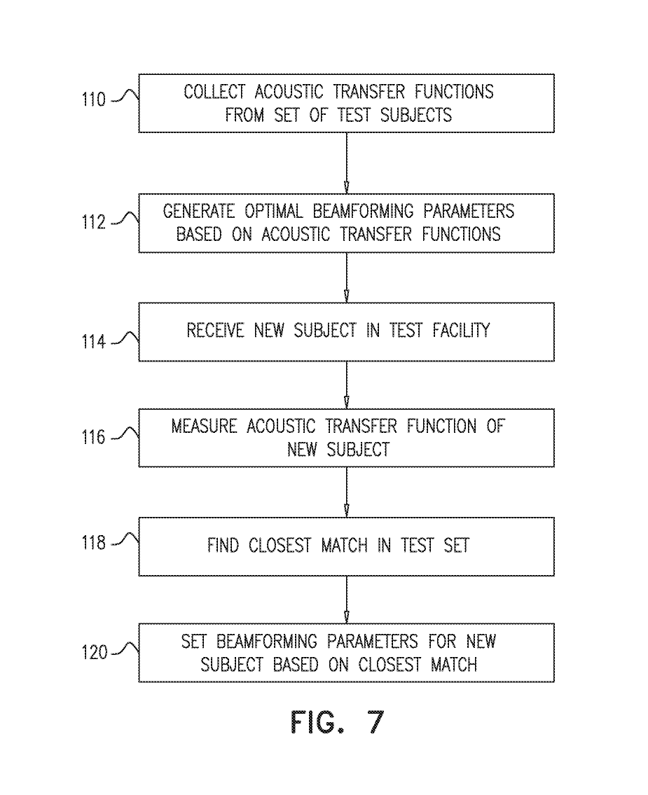

FIG. 7 is a flow chart that schematically illustrates a method for calibrating a directional hearing mode of a hearing aid, in accordance with an embodiment of the invention. This method is useful particularly for directional hearing aids that are worn on the user's body, comprising an array of microphones that are disposed at different, respective locations around a part of the body. For example, such hearing aids may comprise microphones arrayed along spectacle frames, such as hearing aid 90, or may have the form of a necklace. As explained earlier, processing circuitry of the hearing aid mixes the electrical signals from the microphones so as to generate an audio output to the subject with a specified directional response.

The method of FIG. 7 develops a database of beamforming coefficients, for application in hearing aids of users have a range of different acoustic transfer functions. The inventors have found that the optimal choice of coefficients for each user of a given type of hearing aid (such as hearing aid 90) is strongly influenced by the acoustic transfer function, which depends, in turn, on physical characteristics of the user's body. (The acoustic transfer function is the relationship, as a function of frequency, between an acoustic signal emitted by a source at a certain location, and the acoustic signal received by a receiver at another location, and depends on the influence of the user's body in proximity to the source and receiver locations.)

To build this database, a computerized recording system records respective acoustic transfer functions of a large group of test subjects, at a transfer function collection step 110. The system typically comprises a general-purpose computer, which is programmed in software to carry out the steps of the present method, along with a memory and appropriate interfaces and auxiliary equipment. The inventors have conceived a rotating stage upon which a person sits while one or more speakers play white noise (or another audio signal as desired). The resultant sound field (including phase and amplitude information) is recorded from an array of (stationary) microphones placed in a series of rings around the subject at different heights. By means of slowly rotating the subject in this apparatus, the actual transfer function of the subject's body may be directly measured. Thus, the exact way in which a specific subject's body affects the incoming sound waves, by absorbing, reflecting, and transmitting various fractions of the wave in different directions, is measured. The use of white noise allows for reconstruction of the transfer function at all frequencies simultaneously.

By measuring a representative sample of humanity, the transfer function of any particular individual chosen later from the general population may be estimated by use of any of a number of techniques, as will be exemplified below. Clustering techniques, such as K-means or the like, may be applied to automatically classify the spectrum of human transfer functions into a number of discrete classes, which may be subsequently used as a basis set with which to describe the transfer function of new subjects.

For each of the measured acoustic transfer functions, the system computes respective optimal beamforming coefficients, at a parameter computation step 112. The coefficients are computed so that when they are applied by the processing circuitry of the hearing aid, the hearing aid generates an audio output with strong directionality and low background contribution. The beamforming coefficients may be defined in either the frequency domain or the time domain. These coefficients may be computed theoretically from first principles, using the known acoustic transfer properties of the body of the test subject.

Additionally or alternatively, the coefficients may be derived or refined empirically. For this purpose, an audio source may be positioned successively at each of a predefined set of locations within the angular aperture of the specified directional response of the hearing aid, while the test subject (whose transfer function has been measured) wears the hearing aid. The audio source is actuated to generate sounds at a certain set of frequencies at each of the locations, and the audio signals output by each of the microphones are recorded. After collecting all the signals over a range of angles and frequencies, the beamforming coefficients are optimized so that the audio output reproduces the sounds with maximal fidelity, while minimizing the contribution to the audio output of acoustic waves originating outside the angular aperture.

Once this process of building a database of acoustic transfer functions and beamforming parameters has been completed, a new subject, who is a candidate to use the hearing aid, can be received in a test facility, at a new subject intake step 114. (Depending on the type of testing to be carried out, the test facility can be a dedicated laboratory, or it can simply be the clinic or shop of the professional who dispenses the hearing aid.) The acoustic transfer function of this new subject is measured, at a candidate measurement step 116. This measurement can be carried out directly, for example using methods similar to those applied at step 110, or it can be estimated. The estimate may be performed, for instance, by having the subject input such information as weight, height, and age, thereby allowing estimate of body shape. Another method would be to snap one or more pictures of the subject, allowing for an approximate 3D reconstruction of the subject's body to be made. In either case, once the body shape is approximately known or estimated, the acoustic transfer function may also be estimated, for instance by means of direct calculation, table lookup, or the like.

Another method for estimation of the acoustic transfer function of the candidate user is to output a signal of known characteristics, for instance originating from a smartphone, while the user wears the hearing aid. The responses of microphones of the hearing aid to this known signal are recorded, and from these multiple recordings, parameters of the acoustic transfer function of the wearer can be determined. By use of the acoustic transfer function (be it measured or calculated), the beamforming algorithm performance can be improved substantially over parameters calculated based on a free-field assumption.

Additionally or alternatively, the estimate of the acoustic transfer function of the candidate user can be enhanced using the database of measured transfer function.

Given the acoustic transfer function of the candidate user that has been found at step 116, the computer searches the database of test subjects to find the acoustic transfer function that most closely matches it, at a matching step 118. This step may likewise be carried out by various techniques, depending in part on the measurement technique that was used at step 116.

One possible approach for step 118 is to match the physical characteristics of the candidate user against those of the test subjects measured at step 110, on the assumption that two individuals with similar physical characteristics will have similar transfer functions. For example, the test subjects at step 110 may provide information including, but not limited to, weight, height, age, sex, race, lifestyle, BMI, waist/bust/neck/head circumferences, and the like. By providing the same physical-characteristic data at step 116, the candidate user can be matched at step 118 with the closest test subject(s) recorded. Then the transfer function of the test subject(s) may be used to estimate the transfer function of the new hearing aid user. In some cases, the estimate may be based on a combination of two or more “nearest neighbors” in the physical parameter space mentioned above (for example, using a weighted average), so as to more accurately represent the actual transfer function of a candidate user who falls between the physical characteristics of two (or more) test subjects.

Alternatively, a candidate user can simply cycle through a catalog of possible transfer functions and select the one providing the best results. In this case, various parameters of the transfer function be adjustable by the user, so as to tailor and customize the transfer function to his desire.

Further alternatively or additionally, to match a measured transfer function to a given candidate user at step 118, the microphone array of the hearing aid may be used to record the response of the hearing aid to audio test signals during the rotating-subject test described above. (The test signals may again comprise white noise, or a series of tones, a chirp, an impulse, or any other suitable function.) This acoustic response gives a direct indication of the transfer function. Once the microphone array response to the test signals is known, it can be matched to the closest response(s) from the test subjects, and the transfer functions of the matching test subjects are used to estimate the transfer function for the candidate user (for instance by weighted averaging as mentioned above).

The audio test signals used in this procedure may be produced by a special-purpose audio speaker (for instance, provided by an audiologist of oculist fitting the subject for hearing-aid glasses), or they may alternatively be generated by the smartphone speaker or by a specially provided speaker on the hearing aid frame, or using one or more of the microphones as speakers. Other possible signals that can be used in the procedure include the voice of the user and ambient noises.

Once the closest match (or matches) has been found at step 118, the beamforming coefficients of the hearing aid are set for the new subject on the basis of the parameters stored in the database for the matching test subject (or subjects), at a parameter setting step 120. When multiple nearest neighbors are found, the beamforming coefficients may be averaged among the nearest neighbors, for example, as a weighted sum. The hearing aid for the new subject is thus set to apply the optimal beamforming coefficients for the subject's specific acoustic transfer function.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Hearing assistance apparatus, comprising:
an array of microphones, which are spaced apart and are configured to produce electrical signals in response to acoustical inputs to the microphones;
an interface, configured for coupling to a mobile telephone; and
processing circuitry, which is coupled to receive and process the electrical signals from the microphones so as to generate a combined audio output by mixing the electrical signals in accordance with a directional response that defines, in response to an instruction received from a user interface of the mobile telephone, a beam direction and an angular aperture around the beam direction, such that the acoustical inputs within the angular aperture are emphasized in the audio output by the processing circuitry, while suppressing the acoustical inputs outside the angular aperture.

2. The apparatus according to claim 1, and comprising a case, which is configured to be physically fixed to the mobile telephone, wherein the case has four sides and a rear face, to which the four sides are connected, which are shaped and sized so that the case fits over the mobile telephone, and wherein the microphones are fixed within at least two of the sides of the case.

3. The apparatus according to claim 2, wherein the case has a rounded rectangular form.

4. The apparatus according to claim 2, wherein the microphones are spaced apart within at least three of the sides of the case.

5. The apparatus according to claim 2, wherein the microphones are embedded in the sides of the case, and wherein the sides contain audio ports extending outward from the microphones in a direction away from the rear face.

6. The apparatus according to claim 1, wherein the array of microphones comprises at least eight microphones.

7. The apparatus according to claim 2, wherein the directional response is dependent on an angular orientation of the case.

8-9. (canceled)

10. The apparatus according to claim 1, wherein the instruction is generated in response to an input received from a user by an application running on the mobile telephone.

11. The apparatus according to claim 1, wherein the interface comprises an audio interface, which is configured to convey the audio output to an earphone.

12. The apparatus according to claim 11, and comprising the earphone, wherein the earphone comprises an inertial sensor, which is configured to generate an indication of a rotational angle of a head of a person wearing the earphone, and wherein the processing circuitry is configured to adjust the directional response in accordance with the indication of the rotational angle.

13-16. (canceled)

17. Hearing assistance apparatus, comprising:
a spectacle frame;
an array of microphones, which are fixed within the spectacle frame and are configured to produce electrical signals in response to acoustical inputs to the microphones;
processing circuitry, which is fixed within the spectacle frame and is coupled to receive and mix the electrical signals from the microphones so as to generate an audio output with a directional response that is dependent on an angular orientation of the frame; and
an inductive coil connected to the spectacle frame and coupled to be driven by the processing circuitry to convey the audio output as a magnetic signal to a telecoil in a hearing aid of a user who is wearing the spectacle frame.

18. The apparatus according to claim 17, wherein the inductive coil is rotatable relative to the spectacle frame so as to optimize a mutual inductance between the inductive coil and the telecoil.

19. A method for hearing aid calibration, comprising:
providing a hearing aid comprising an array of microphones that are configured to be disposed at different, respective locations around a part of a body of a human subject who is wearing the hearing aid, and processing circuitry coupled to receive and mix electrical signals from the microphones so as to generate an audio output to the subject with a specified directional response;
recording respective acoustic transfer functions of a plurality of test subjects;
defining respective optimal beamforming coefficients to be applied by the processing circuitry of the hearing aid in generating the audio output for each of the acoustic transfer functions;
for a new subject who is a candidate to use the hearing aid, finding a nearest match among the recorded acoustic transfer functions; and
setting the hearing aid for the new subject to apply the respective optimal beamforming coefficients that were defined for the nearest match among the recorded acoustic transfer functions.

20. The method according to claim 19, wherein the hearing aid comprises a spectacle frame in which the array of microphones is fixed.

21. The method according to claim 19, wherein defining the respective optimal beamforming coefficients comprises:
positioning an audio source at each of a first set of locations within an angular aperture of the specified directional response;
actuating the audio source to generate sounds at a second set of frequencies at each of the locations; and
setting the beamforming coefficients so that the audio output reproduces the sounds with a maximal fidelity, while minimizing a contribution to the audio output of acoustic waves originating outside the angular aperture.

22. The method according to claim 19, wherein finding the nearest match comprises measuring an acoustic transfer function of the new subject, and matching the measured acoustic transfer function of the new subject to the recorded acoustic transfer functions.

23. The method according to claim 19, wherein finding the nearest match comprises matching physical characteristics of the new subject to the test subjects.

24. A method for hearing assistance, comprising:
providing an array of microphones spaced apart and configured to be interfaced to a mobile telephone;
mixing electrical signals from the microphones in accordance with a directional response that defines, in response to an instruction received from a user interface of the mobile telephone, a beam direction and an angular aperture around the beam direction, so as to generate a combined audio signal, such that the acoustical inputs within the angular aperture are emphasized in the combined audio signal, while suppressing the acoustical inputs outside the angular aperture; and
outputting the combined audio signal to an earphone.

25. The method according to claim 24, wherein providing the array of microphones comprises providing a case, which is configured to be physically fixed to the mobile telephone, wherein the case has four sides and a rear face, to which the four sides are connected, which are shaped and sized so that the case fits over the mobile telephone, and wherein the microphones are fixed within at least two of the sides of the case.

26. The method according to claim 25, wherein the case has a rounded rectangular form.

27. The method according to claim 25, wherein the microphones are spaced apart within at least three of the sides of the case.

28. The method according to claim 24, wherein the array of microphones comprises at least eight microphones.

29. The method according to claim 25, wherein the directional response is dependent on an angular orientation of the case.

30-31. (canceled)

32. The method according to claim 24, wherein the instruction is generated in response to an input received from a user by an application running on the mobile telephone.

33. The method according to claim 24, wherein the earphone comprises an inertial sensor, which is configured to generate an indication of a rotational angle of a head of a person wearing the earphone, and wherein generating the audio output comprises adjusting the directional response in accordance with the indication of the rotational angle.

34. A method for audio processing, comprising:
providing a case, containing an array of microphones spaced apart within the case, and configured to be physically fixed to a mobile telephone;
capturing a video image, using a camera in the mobile telephone, of an audio source; and
mixing electrical signals from the microphones in accordance with a directional response that is directed toward the audio source so as to generate a combined audio output signal.

35. The method according to claim 34, and comprising recording the video image together with the combined audio output signal.

36. The method according to claim 34, and comprising transmitting the video image together with the combined audio output signal over a communication network.

37. The apparatus according to claim 1, wherein the processing circuitry is contained in the mobile telephone.

38. The apparatus according to claim 1, wherein the processing circuitry is external to the mobile telephone.
